(19) United States
(12) Patent Application Publication
(10) Pub. No.: US 2006/0175529 A1
(43) Pub. Date: Aug. 10, 2006

(54) Large-area detector

(76) Inventors: Eric S. Harmon, Norfolk, MA (US); David B. Salzman, Chevy Chase, MD (US); James T. Hyland, Hamden, CT (US); Jerry M. Woodall, New Haven, CT (US); Robert D. Koudelka, Albuquerque, NM (US)

Correspondence Address: Goodwin Procter LLP;Attn: David Garrod, Ph.D. Esq., 599 Lexington Avenue, New York, NY, 10022, US

(21) Appl. No.: 10/983,452

(22) Filed: Nov. 8, 2004

Related U.S. Application Data
(60) Provisional application No. 60/518,251, filed on Nov. 6, 2003.

(51) Int. Cl. H01J 43/04

(52) U.S. Cl. 250/207; 250/214 R

(57) ABSTRACT

A solid state photodetector is disclosed comprising a multiplicity of photodetector elements, each element using clamped Geiger mode gain to achieve high sensitivity and high speed. The elements are connected together using a common anode to sum their outputs, allowing operation with gray-scale response over a large total photosensitive area. In the preferred embodiment, high speed performance is achieved by isolating each element from the bias supply by means of an integrated series resistor.

### CROSS-REFERENCE TO RELATED APPLICATION

This application claims priority from the U.S. Provisional Patent Application “Big-Area Detector,” filed Nov. 6, 2003 as docket L3176-018, Ser. No. 60/518,251, incorporated herein by reference.

### FIELD OF THE INVENTION

This invention relates generally to the fields of solid state physics and electronics, more particularly to the design and fabrication of semiconductor photodetectors, and still more particularly to the design, fabrication and structure of elements of photodetectors using avalanche gain, and still more particularly to the design, fabrication, and structures of such photodetectors with a large effective photosensitive area.

### BACKGROUND OF THE INVENTION AND LIMITATIONS OF THE PRIOR ART

The detection of a low optical flux over a large photosensitive detector area, with fast rise times and wide bandwidth frequency response, at or near room temperature, generally requires gain in the photodetector itself, not just in a preamplifier following the photodetector. Internal gain is needed to overcome the high electrical noise inherent in high-speed electrical preamplifiers. The best prior art preamplifiers produce electrical noise equivalent to about 100 input-referred electrons per optical pulse for pulse bandwidth above 100 MHz at room temperature, so a signal of less than about 100 photons divided by the photodetector's quantum efficiency would be below the noise floor. Repetitive sampling techniques, cryocooling, and slowing the bandwidth can sometimes be used to increase the signal-to-noise ratio (“SNR”) of the pre-amplifier, but are not general solutions. In addition, a large active area photodetector generally has a high capacitance, since the capacitance usually scales linearly with the photodetector area. The noise of a transimpedance amplifier usually depends on its input capacitance, so increasing the photodetector capacitance results in increased noise. Furthermore, the frequency response of the photodetector is degraded at higher capacitance, requiring lower values of feedback resistance in the transimpedance amplifier to maintain the frequency response, which also leads to higher electrical noise in the transimpedance amplifier. However, generating many more than 1 electron per photon captured in the photodetector can offer a general solution to improving SNR, particularly for large area detectors.

The principal prior art solutions to the problem of large photosensitive area, high speed detection of low optical flux include technologies based on high voltages in high vacuums (e.g. the photomultiplier tube (PMT), the microchannel plate (MCP), the intensified photodiode, and the electron-bombarded photodetector), all of which are fragile and expensive, and generally exhibit macroscopic dimensions incompatible with the microscale dimensions needed for many well-known and emerging applications. Alternative solutions such as superconducting tunnel junctions (See G N Gol'tsman, O Okunev, G Chulkova, A Lipatov, A Semenov, K Smirnov, B Voronov, A Dzardanov, C Williams, and R Sobolewski, “Picosecond superconducting single-photon optical detector,” Applied Physics Letters, v. 79, p. 705, (2001).) or visible light photon counters) (VLPCs) (S Takeuchi, J Kim, Y Yamamoto, and H H Hogue, “Development of a high-quantum efficiency single-photon counting system,” Applied Physics Letters, vol. 74, p. 1063, (1999).) only provide sufficient low-noise gain when operated at cryogenic temperatures, greatly limiting their applicability.

Distributed amplification using avalanche gain allows so-called charge-multiplying device (“CMD”) variants of a charge-coupled device (“CCD”) to achieve low noise amplification compatible with detection of single photons, but these devices are not generally operable at high bandwidths because the serial readout architecture of the CCD photodetector array results in slow (<1 MHz) frame rates, and the charge-multiplying readout generally occupies a significant amount of chip area, necessitating a multiplexed readout rather than a dedicated amplifier for each pixel when used with a CCD detector array.

Gating or streaking techniques are often invoked to reject background noise and isolate a signal, or let any slow detector operate with a fast shutter, but are not general solutions for high duty cycle detection of arbitrary signals. Gating makes assumptions about knowing the timing of each event and having a low duty cycle, neither of which assumptions applies in the general case.

Semiconductor photodetectors have historically been of lower quality, but workable. Conventional avalanche photodiodes (“APDs”) can offer linear amplification e.g. (10-100-fold) across useful dynamic ranges (e.g. 10,000:1) but are unable to detect single photons above their noise floor at or near room temperature when operating with detection bandwidths above about 10 MHz bandwidth. Furthermore, while APDs generally have improved gain-bandwidth products and lower capacitance than devices without gain (such as PIN photodiodes), linear scaling of capacitance with area still occurs, making it difficult to simultaneously achieve high gain, low noise, and large photosensitive area.

Geiger mode avalanche gain in semiconductor detectors, can provide sufficiently low-noise gain to detect single photons against the detector's background noise. APDs using Geiger mode are often called single-photon avalanche detectors, or “SPADs,” to distinguish them from conventional, linear APDs. However, SPADs generally exhibit small photosensitive areas in order to limit the dark noise contribution, which generally scales with device area. In addition SPADs do not distinguish a single-photon event from a multiple-photon event. A SPAD is a bistable device which detects a plurality of electrons (whether photogenerated or of thermal origin), and produces a binary output signal tantamount to “Yes, electrons were detected,” or “No, zero electrons were detected.” A SPAD is capable of detecting single electrons, hence single photons if said photon generates an electron in the active region of the device.

SPADs are operated with an excess bias voltage, defined as the operating voltage above the breakdown threshold. The breakdown threshold voltage is determined by the operating point where the feedback between electron and hole impact ionization is approximately unity. For bias above the breakdown threshold voltage, positive feedback between electron and hole impact ionization events occur, resulting in infinite gain. Operation in this unstable regime of bias above the breakdown voltage normally would produce a runaway current which would cause catastrophic failure due to excessive power dissipation. However, if the excess bias voltage is applied as a voltage step, then before the step no free carriers will be present to initiate breakdown, so no current will flow. After the step, absorption of a photon, ionizing radiation, or thermal generation will present a free charge carrier (i.e. electron or hole) to the APD's multiplication region, initiating the infinite avalanche gain process and inducing a Geiger event. The positive feedback between electron multiplication and hole multiplication causes the current rises exponentially with time. Catastrophic destruction is averted by external circuitry, which generally limits the external supply current to a magnitude less than the internal Geiger current, enabling the Geiger current to discharge the device capacitance and thereby lower the voltage until the device is no longer biased beyond the breakdown threshold, quenching the Geiger event. While it may be possible for active external circuitry to react to a Geiger event and assist in the quenching process by providing an additional discharge current, such active quenching is rarely faster than the self-quenching due to the Geiger discharge unless the bias supply current is too high (i.e. is not sufficiently limited) or the device capacitance is too large.

After the device has been quenched, a hold-off time is then necessary to allow any free or stored charge to be swept from the active region of the device, followed by a transient recharging cycle to restore the excess bias across the APD. So-called active quenching circuits often act to provide a significant speed-up of the recharge cycle. This quenching, hold-off, and recharge cycle comprise a dead-time during which the pixel is generally unable to detect additional incident photons. At high count rates (typically 10-100 kcps (kilocounts per second) for passively quenched APDs and 1-10 Mcps for actively quenched APDs), a SPAD saturates, and is unable to detect incident photons for a significant percentage of the time. The appreciable dead-time makes scaling a SPAD to large area problematic because the dark count rate associated with thermally generated carriers scales in proportion to the area, so larger devices are dominated by dark counts and their associated dead-time, reducing the portion of time during which the device is sensitive to light from true signals.

Recently, arrays of SPADs have been developed which partially solve the problems of discrete SPAD elements. (See Brian F. Aull, Andrew H. Loomis, Douglas J. Young, Richard M. Heinrichs, Bradley J. Felton, Peter J. Daniels, and Deborah J. Landers, “Geiger-Mode Avalanche Photodiodes for 3D Imaging,” Lincoln Laboratory Journal, v 13, p. 335 (2002). See http://www.ll.mit.edu/news/journal/pdf/13_{—}2aull.pdf, and P Buzhan, B Dolgoshein, L Filatov, A Ilyin, V Kantserov, V Kaplin, A Karakash, F Kayumov, S Klemin, E Popova, and S Smirnov, “Silicon photomultiplier and its possible applications,” Nuclear Instruments and Methods in Physics Research A. v. 504, p. 48, (2003).) The input optical signal can be spread across an array of APD pixels, sharing the photons among a multiplicity of parallel avalanches. Such an array can be used to estimate the amplitude of an incident light pulse, since distributing the input photons across an array results in simultaneous detection events, with the number of triggered pixels proportional to the input photon flux.

Two general approaches to combining the output of an array of SPADs provide dynamic range. One employs an external readout integrated circuit (“ROIC”) to detect each individual Geiger event, using a dedicated circuit for each SPAD pixel. This approach is useful for imaging the spatial distribution of photons as well, but limits the density of pixels because of the pitch required to fit the detection and readout circuitry. The hybrid integration of the ROIC with the SPAD array necessitates some means for interconnecting a large number of connections (thousands to millions or more), introducing significant yield losses and additional failure mechanisms. Another approach employs monolithically integrated quenching circuitry for each pixel and array circuitry to combine the output of the array (or of a sub-array). A simple example of this monolithically integrated approach is to incorporate a simple resistive current limiter at the cathode (or anode) of each pixel, while combining the array outputs using a simple common anode (or common cathode) arrangement by simply connecting the anodes (or cathodes) of each pixel together. The common anode readout allows simple analog summation of the currents from each Geiger event. This approach has the advantages of not constraining the density of pixels, and of being readily implemented using monolithic integration of a common contacting layer for the SPAD arrays. Sharing a common anode (or common cathode) among pixels enables analog summation of the essentially same-sized charge pulses contributed by each Geiger mode pixel into a gray-scale, analog-like result. The solid state microchannel plate (SSMCP) is an example of such an array, using limited gain per photodiode and preferably SAM structures. Similarly, sharing a number of common anodes (or common cathodes) among a larger number of pixels can provide comparable benefits, along with additional benefits. Some of these additional benefits include providing a detector encompassing an array of gray-scale pixels, typically in a line or rectangular format, wherein each gray-scale pixel itself aggregates Geiger mode photodiode pixels such as an SSMCP.

Other monolithically integrated circuits are envisioned, including simple integrated amplifiers for each pixel (i.e. common collector amplifiers, with each pixel connected to the base of a heterojunction bipolar transistor, and using analog summation of the collector outputs to provide an additional transistor gain for each pixel), and simple threshold circuits (i.e. comparators) to output a precisely defined digital pulse for each detected Geiger event, which may then be summed through a common collector readout.

However, these prior art array solutions do not addresses other fundamental limitations of SPADs and SPAD arrays, including optical cross-talk, low geometrical fill factor, low photosensitive area, high after-pulsing rates, long dead-times, poor frequency response, poor time resolution, excessive power dissipation, and limited spectral sensitivity. Optical cross talk scales as the product of optical generation inside a triggered pixel, the total geometric cross section for interaction between two pixels, and the single-photon sensitivity of other pixels. (See J C Jackson, D Phelan, A P Morrison, R M Redfern, and A Mathewson, “Characterization of Geiger Mode Avalanche Photodiodes for Fluorescence Decay Measurements,” Proceedings of SPIE Vol. 4650-07, January 2002.) Geiger mode avalanche gain process in SPAD devices typically generate 10⁶-10¹⁰ electron-hole pairs in the active region of a device, some of which will radiatively recombine, emitting secondary photons. Though all reverse-biased semiconductor junctions emit light proportional to current flow, the high gain and high electrical field in SPADs often generate light efficiently and copiously. Some of these secondary photons may reach another pixel of the array. Since absorption of a single photon can trigger a pixel, the absorption of a secondary photon mimics a true event and triggers another pixel, causing a false detection event.

The geometrical fill factor for SPADs is the proportion of surface area capable of detecting single photons. Low geometrical fill factor follows from the need to isolate neighboring pixels geometrically in order to reduce optical cross talk, or the need to increase inter-pixel gutter margins or pitch to accommodate large per-pixel devices such as ROIC cells. An opaque barrier between pixels can be used to decrease optical cross talk while keeping a higher fill factor, but takes up area itself. Lens arrays can be used to increase the effective fill factor, but inevitably limit the numerical aperture of the pixels, which limit the utility and generality of an array.

The dark count rate of each SPAD pixel scales as its area, so in practice, the expected noise floor limits the maximum designable area. If the dark count rate of a pixel is too high, its photo-response becomes dominated by dead-time, making it inefficient as a photodetector. Increasing the effective active area of the photodetector instead by combining the outputs of an array of smaller pixels totaling the same area can avoid domination by dead-time at the same dark count rate. This effect occurs because the dead-time of individual pixels does not affect untriggered pixels.

After-pulsing occurs when charge carriers created by the avalanche process are trapped briefly in defects and subsequently re-emitted, initiating a new Geiger event. The likelihood scales as the trap density and the number of carriers, and therefore scales with photodetector element volume (proportional to area) and gain. This trap-and-release mechanism is thermally activated, so is drastically worse at lower temperatures where storage times are longer.

The dead-time of a SPAD is the time period after a detection event where the device is no longer capable of detecting photons. While it is desirable to have as short a dead-time as possible to ensure availability of the detector element to detect subsequent photons, dead-time is bounded by the external circuitry reset speed, which in turn is limited by the gain-bandwidth of the circuitry, and after-pulsing, which is limited by trapping effects. External circuitry must be connected to the SPAD to allow the device to shut Off after a detection event (otherwise it would be catastrophically destroyed as the avalanche gain process tends towards infinite gain and therefore infinite current), wait a predetermined time interval for substantially all of the free carriers to be swept out of the active region and be released from traps, and then reset the SPAD to a bias above breakdown to rearm the pixel for Geiger mode detection of the next event. Current implementations of SPADs exhibit dead-times in the range of twenty ns to tens of μsec.

The frequency response of a discrete SPAD pixel must be considered separately from the frequency response of a photodetector which aggregates the output of an array of SPAD pixels. The pixel frequency response is principally determined by three components: the rise-time of the Geiger detection event, the hold-off time, and the reset time necessary to recharges the pixel bias above breakdown, setting the device into the active Geiger mode. The rise-time of the Geiger detection event is generally dominated by the build-up time of the avalanche gain process. This build-up time depends on a number of parameters, including impact ionization coefficients (both electron and hole ionization coefficients), and the Geiger mode gain (defined as the number of electron-hole pairs generated during a Geiger event). The fact that Geiger mode operation requires feedback between electron and hole ionization generally makes the build-up time faster if electron and hole ionization coefficients are approximately equal. (See James S. Vickers, US patent application S/N US 2003/0098463 A1, “Avalanche Photodiode for Photon Counting Applications and Method Thereof,” May 29, 2003.) The Geiger event causes an exponentially increasing current pulse to appear at the output until the gain mechanism is abruptly shut Off as the device is quenched. After the device is quenched, it is identical to an APD operated in the linear mode, with the fall-time of the Geiger current dominated by the transit time of the carrier population through the device's depletion region. Next, the hold-off time is determined by a combination of the response speed of the circuitry, as well as the dead-time requirements necessary to ensure that after-pulsing is not significant. Finally, the rise-time of the reset event may also affect the pixel frequency response, particularly for approaches where the pixel is recharged through a high value resistor, resulting in a long RC time constant. The output pulse of a SPAD generally has a rise-time determined by the build-up time of the Geiger event, and a fall-time determined by the combination of the hold-off time and the reset time.

The frequency response of an aggregated array of SPADs may differ from the frequency of an individual SPAD detector element. The array response determined primarily by the build-up time, which sets the frequency response of a SPAD array where the outputs of the array sum to form a single output waveform. While the hold-off and reset times together define a dead-time where an individual pixel is unable to detect a subsequent Geiger event, other pixels of the array remain available to detect additional events, so the primary metric for the frequency response of an array is the build-up time. In particular, if the pixels comprising the array are connected in a common anode (or common cathode) arrangement, each Geiger event injects a current pulse into the common anode (or common cathode) with a rise-time dominated by the build-up time, and a fall-time dominated by the transit time through the depletion region of the device, after which the pixel is effectively disconnected from the common anode (or common cathode) readout and exhibits a high resistivity until the next detection event.

The time resolution of a SPAD indicates the ability of the device to determine a photon's absolute arrival time accurately. The fundamental limit to the time resolution of a SPAD is usually governed by jitter in the output pulse response compared to the incident photon arrival time. This jitter follows from two primary effects: the time a photoelectron takes to reach the avalanche gain region of the device, and the time a Geiger event takes to build-up. Time resolution is also a function of the external timing circuitry, which may contribute its own inherent jitter component.

The pulse-pair resolution describes the smallest time interval over which two successive photons can be distinguished. The pulse pair resolution is a relative measurement and may allow less uncertainty than the absolute time resolution.

Power dissipation also limits SPAD performance and reliability by raising the operating temperature and thereby increasing noise (dark counts) and failure rates. High internal gains, typically in the range of 10⁶-10¹⁰, generate and dissipate a significant amount of power when devices are operated at high count rates. Power dissipation can be particularly problematic for high density pixel arrays, where a pixel may by heated by power dissipated by nearby pixels or their ROIC circuitry. ROIC circuits usually dissipate far more power than pixels, so power density may limit pixel pitch by virtue of limiting ROIC pitch.

The spectral responsivity of a SPAD is determined by the probability of a photon converting into an electron-hole pair in the absorption region of the device. Most high performance SPADs have been produced using semiconducting silicon, limiting application to wavelengths where silicon has high absorption. Since dark noise (dark counts) scales as the volume of material, very thin active areas are commonly used. Consequently, silicon achieves high sensitivity only for wavelengths below about 900 nm. Above there, the probability of absorbing photons in the active region of the device is low.

SPADs have been demonstrated using other semiconductors too, but are often dominated by dark counts and after-pulsing. The prior art non-silicon SPADs generally operate with a large fraction of dead-time, very low duty cycle, and low availability.

### OBJECTS OF THE INVENTION

Nearly all of the above limitations of SPADs occur, directly or indirectly, as a result of excessively high internal gain. Most prior art designs have sought low noise and high internal gain to overcome higher noise from preamplifier read-out. But the 10⁶-10¹⁰:1 gain of a typical SPAD is at least 100 times higher than optimal for low noise detection of single photons. Excellent modern electrical circuitry achieves a readout noise of about 100 electrons/pulse (for pulse speeds in excess of 100 MHz at room temperature), so single-photon sensitivity can readily be achieved if avalanche gain upstream from the electronics multiplies each photon in to (approximately) 10³ to 10⁶ electrons.

The gain of a SPAD is determined primarily by two factors: the total device capacitance (C) and the excess bias (ΔV) on the device. In order to quench a Geiger event, the excess bias across the SPAD must be negligible or negative (when using the convention that the excess bias is a positive number when the magnitude of the bias is greater than the magnitude of the breakdown threshold voltage). Since this excess bias is applied across the device capacitance, the minimum gain of a passively quenched Geiger mode APD is C×ΔV. In practice, the actual gain will be somewhat larger, because the passive quench circuitry provides a recharge current to the SPAD, which opposes the Geiger discharge current, so requires an additional discharge current component. Furthermore, it is possible for a Geiger event to cause the voltage to overshoot the breakdown threshold, resulting in a larger voltage swing than ΔV and a higher gain. Note that voltage overshoot may be desirable because the time period where the bias is below the threshold voltage acts as a hold-off time, allowing free carriers to be swept from the active region of the device. Limiting the Geiger mode gain by limiting ΔV is also possible, though the probability of initiating a Geiger event is proportional to ΔV, so using low ΔV to achieve low gain is generally a bad idea. For certain semiconductor materials with strong feedback between electron and hole ionization events, low ΔV can be achieved while maintaining high Geiger probabilities. Strong feedback can be achieved using materials where the ratio between hole ionization and electron ionization probabilities (the k factor) is close to unity. Strong feedback can also be achieved by using a wide gain region, which increases the probability of feedback by increasing the integrated probability (across the whole gain region) of both hole and electron ionization events (S Wang, F Ma, X Li, G Karve, X Zheng, and J C Campbell, “Analysis of breakdown probabilities in avalanche photodiodes using a history dependent analytical model,” Applied Physics Letters, 82(12), pp. 1971-1973, (24 Mar. 2003).)

By limiting the gain of a SPAD to less than 10⁶, certain fundamental limitations of SPAD arrays and SPADs more generally can be mitigated:

Optical cross talk: Since the optical generation rate of a SPAD is determined by the current flowing it, limiting the gain reduces the optical generation rate along with the current. Reducing the gain by an order of magnitude reduces the number of secondary photons and the optical cross talk in arrays by the same factor.

Geometrical fill factor: Once gain is lowered, pixels can be placed closer together within a given optical cross talk budget, at least to the extent that optical cross talk is managed by pixel separation instead of more complex techniques like trench isolation and opaque barriers.

After-pulsing: The after-pulsing rate scales as density of traps and the number of carriers available to interact with the traps, hence as the gain, so reducing the number of free carriers reduces the capture probability and after-pulsing rate. (See W J Kindt and H W van Zeijl, “Modelling and Fabrication of Geiger mode Avalanche Photodiodes,” IEEE Transactions on Nuclear Science, 45, p. 715, (June 1998).)

Frequency response: An avalanche entailing fewer carriers typically exhibits a faster rise-time and fall-time in a pixel, hence a higher frequency response. Lower gain allows a higher bandwidth at a given gain-bandwidth product. Lower gain can be achieved, in part, by lowering the device capacitance, which also allows improved frequency response by reducing capacitive delays.

Dead-time: A higher frequency response gives a shorter dead-time and higher per-pixel availability. In addition, the hold-off time can likewise be reduced because after-pulsing is reduced, enabling significant reductions in dead-time to be achieved.

Time resolution: A smaller charge pulse can have a sharper rising edge, and a detection event producing a sharper rising edge allows pulse detection circuitry to operate with less jitter.

Power dissipation: Power dissipation is set by the current-voltage product IV, so lowering the current by lowering the gain lowers the power. Lowering the power dissipation per detection event allows more detection events per second (higher pulse rates) and higher pixel densities to the extent they were limited by a temperature budget.

Spectral sensitivity: Spectral sensitivity depends on the semiconductor material used in the absorption region of the SPAD, so more freedom in the choice of semiconductor material supports more narrowness or breadth, as needed, in the spectral sensitivity. The dark count rate of SPADs realized in materials other than silicon is often dominated by after-pulsing, so reducing the after-pulsing rate, by reducing the Geiger mode gain, is key to making more semiconductors acceptable as absorption region candidates. Although the gain and absorption regions of a SPAD may be formed from the same or different semiconductor materials, the regions must be compatible enough for the defect density at their interface to be low enough to avoid swamping the device with dark counts caused by thermal generation in the absorption region and gain region, and after-pulsing from the gain region. (Note that in an APD with separate absorption and multiplication (SAM) layers, the gain region only injects one type of carrier into the absorption region, and the act of trapping of said carrier type will not itself create an after-pulse because the carrier type is repelled from the active gain region by the applied electrical field.)

In practice, all prior art structures and methods for limiting the Geiger mode gain using active circuitry have proven unsatisfactory. External circuitry is ordinarily required to detect a Geiger event, so a popular approach is to speed up the quenching process by actively reducing the voltage across an avalanching device, which also serves to reduce the dead-time and increase the duty cycle. (See S Cova, M Ghioni, A Lacaita, C Samori, and F Zappa, “Avalanche photodiodes and quenching circuits for single-photon detection,” Applied Optics, 35, p. 1956, (April 1996).) Active quenching circuitry requires a gain-bandwidth product on the order of 10⁶-10⁸ V/A times 10⁸ MHz in this example, since the Geiger event must be detected when the gain is low (e.g. 10³ carriers), and amplified to a macroscopic current pulse to generate a voltage pulse sufficient to cut the excess bias voltage across the APD to below breakdown. Such high gain entails a significant circuit delay due to fundamental gain-bandwidth limitations of circuitry, e.g. well below 100 MHz at high gain. Since the rise-time of a Geiger mode avalanche can be sub-ns to tens of ns, quenching a Geiger event with active circuitry is often incompatible with quenching to achieve low gain.

In contrast to active quenching, passive quenching is capable of achieving very fast quench times, and has already demonstrated 2.5 ns. (See A Rochas, G Ribordy, B Furrer, P A Besse, and R S Popovic, “First Passively-Quenched Single Photon Counting Avalanche Photodiode Element Integrated in a Conventional CMOS Process with 32 ns Dead Time”, Proceedings of SPIE vol. 4833, p. 107, (2002).) This is because the Geiger mode gain mechanism can be extremely fast, building up current within the device itself in tens or hundreds of ps. Provided that this internal current is not dissipated by external circuitry, the internal current is capable of discharging the device capacitance rapidly, limited only by the internal gain-bandwidth of the Geiger mode APD (typically in excess of 100 THz) and by the device capacitance. Indeed, the gain of a passively quenched Geiger mode APD is determined by the capacitance, and lowering the capacitance provides a means of lowering the gain.

Consequently, it is an object of the invention to use a pixelated arrays of SPADs to achieve large photosensitive areas with high sensitivity, wide dynamic range, and high frequency response. This is the solid state analog of the vacuum MCP, and so is termed a solid state microchannel plate. Combining a large number of small area SPADs into a single photodetector device de-couples the photosensitive area from the capacitance of the individual SPAD elements in the array. This greatly reduces dependence upon total photosensitive area of the frequency response and gain of a photodetector, allowing the photosensitive area to be increased without encountering unacceptable degradation of the frequency response and or excessive gain. Limited gain is achieved by lowering the per-pixel capacitance and excess bias such that the charge dissipated per detection event (related to the Geiger mode gain) is less than 10⁶. In some arrangements, it will be below lower figures, like 10⁵, 10⁴, etc. This limited Geiger mode gain advantageously lowers optical cross talk, after-pulsing, and power dissipation per detection event, which in turn allow higher pixel densities and higher fill factors to be achieved by easing inter-pixel spacing constraints.

While some prior art attempts to reduce pixel noise by using very small photodetector active areas had the benefit of reducing capacitance, their performance improvement was countered by their low detectivity arising from the reduction in sensitive areas and fill factors. Furthermore, it is an aspect of the invention to achieve lowered gain while maintaining large pixel active areas, particularly through the use of SAM APD structures, allowing the noise of the narrow band gap absorption region to be decoupled from the capacitance of the device by allowing a thick, low noise, high Geiger probability wide band gap gain region to be inserted into the depletion region of the device.

Another object of the invention is to achieve increased detectivity through the use of lowered gain. Increased detectivity is achieved through the use of higher pixel densities and higher fill factors. Similarly, spectral responsivity can be extended to longer wavelengths because lowered gain results in lowered after-pulsing, which often limits the performance of longer-wavelength single-photon detectors. In addition lowering the gain allows higher pixel availability to be achieved since lower gain enables shorter pixel dead-times by lowering after-pulsing.

Another object of the invention is to achieve ungated operation. SPADs often require their photosensitivity to be gated to within a short time interval, in order to reject the noise, dead-time and after-pulsing. Decreasing a pixel's dead-time and after-pulsing increases its availability, reducing or eliminating the need for gating. Furthermore, the availability of a SPAD array is much higher than the availability of a single-pixel photodetector of the same large area, because in the SPAD array only a small fraction of the array elements will be unavailable at any given time, whereas for the single pixel large area photodetector the whole active area is unavailable during the pixel dead-time.

Another object of the invention is to achieve faster pixel rise-time and lower system jitter for circuitry that triggers on detection events. Faster pixel rise-time is achieved because limiting the gain generally allows higher bandwidth to be achieved due to conventional gain-bandwidth constraints. Furthermore, since diffusion of the Geiger event across a SPAD pixel area is a function of the both the SPAD area and capacitance, small pixels result in lower faster diffusion of the Geiger event across the entire SPAD pixel.

Another aspect of the invention is to achieve higher photodetector device bandwidth, particularly for devices that aggregate the output of the SPAD array by using a common anode or similar connection. The bandwidth of such aggregate arrays is limited primarily by the current response of the SPAD pixel elements, which is related to the rise time of the SPAD element. Faster pixel rise-times therefore leads to higher aggregate array bandwidth.

The preceding and additional objects of the present invention include increased photodetector photosensitive area by using an array of SPADs with reduced Geiger mode gain; increased photodetector frequency response by using an array of SPADs with reduced Geiger mode Gain; increased large-area photodetector frequency response by using an array of SPADs with low capacitance; decreased after-pulsing in large photodetector arrays by lowering the per-pixel gain; decreased optical cross talk in large arrays of photodetectors by lowering the gain; increased fill factor of large photodetector arrays by decreasing pixel spacing through lowered optical cross talk; reduced dead time in large photodetector arrays by lowering the gain; increased duty cycle of large arrays of photodetectors by reducing the dead time; reduced slew, rise-time, fall-time, or width of the current pulses produced in large arrays of photodetectors; reduced power dissipated in large arrays of photodetectors; increased or extended the wavelength gamut of spectral sensitivity of large arrays of photodetectors; detection of single-photon events in large photodetector arrays; reduced dark count rates in large photodetector arrays; and/or solutions to one or more problems limiting efficacy of prior art structures and methods.

Some other objects of the present invention, particularly regarding an ensemble of SPADs forming an array used as a single photodetector, are to reduce the overall dead-time, especially to effectively zero; increase the overall duty cycle; reduce optical cross talk; reduce absolute timing jitter; reduce the relative, pair-wise timing jitter; increase the pulse-pair resolution; reduce the pixel pitch; increase the geometrical fill factor; provide an output signal proportional to the number of photons in an input signal; discriminate dark counts from signal by thresholding the input at a minimum number of simultaneous photons greater than 1; simultaneously provide high detectivity, high Geiger mode performance, linear gray-scale detection capability, and low-noise gain; optimize pixel and array structures and geometries to achieve limited Geiger mode gain with high photosensitivity on large areas; and/or solve one or more problems limiting efficacy of prior art structures and methods.

### BRIEF DESCRIPTION OF THE DRAWINGS

Various aspects, features, advantages and applications of the present invention are described in connection the Description of Illustrative Embodiments below, which description is intended to read in conjunction with the accompanying set of drawings, in which:

FIG. 1 depict the prior art approach to high-speed, ultra-sensitive optical detection using a microchannel plate (MCP) photomultiplier tube (PMT). FIG. 1A illustrates the layout of the MCP electron multiplier, and FIG. 1B provides a close-up cross-sectional view of two of the pores of the MCP.

FIG. 2 illustrates the passive quenching circuitry approach, with the circuit diagram in FIG. 2A and the equivalent circuit model in FIG. 2B. FIG. 2C shows the simulated current response of the simulated fast passive quenching approach, and FIG. 2D shows the simulated voltage response of the fast passive quenching approach. FIG. 2E shows a parallel-connection of N equivalent circuits simulating an N element array. FIG. 2F shows the voltage response for a single triggered circuit with 1, 100, and 1000 equivalent circuits connected in parallel. FIG. 2G shows the voltage response for 1, 2, and 10 simultaneously triggered circuit with 1000 equivalent circuits connected in parallel.

FIG. 3 illustrate the thermal contribution to dark count rates as a function of the semiconductor absorption region. FIG. 3A show the thermal dark generation rate as a function of temperature for various semiconductor absorption regions. FIG. 3B shows the thermal dark generation rate as a function of effective cutoff wavelength of the absorption region, and FIG. 3C shows how an array of single photon detectors may be advantageously combined to reject uncorrelated dark counts while accurately detecting correlated signal photons.

FIG. 4 show the preferred embodiment. FIG. 4A shows the epitaxial layer structure of the preferred embodiment. FIG. 4B shows how an array of two pixels can be fabricated from the layer structure shown in FIG. 4A.

FIG. 5 show an alternative geometry for two pixels fabricated from the layer structure shown in FIG. 4A.

FIG. 6 shows an alternative layer structure with a monolithic passive quench resistor integrated underneath the Geiger mode APD.

FIG. 7 shows an alternative layer structure with an additional, capacitance reduction layer inserted into the depletion region of the device.

FIG. 8 show the geometrical pixel layouts on a square lattice

FIG. 9 show various hexagonal close packed pixel geometries. FIG. 9A shows a simple array of Geiger mode pixels on a hexagonal close packed lattice. FIG. 9B shows an array of Geiger mode pixels on a hexagonal close packed lattice with a guard ring structure for field shaping.

### DETAILED DESCRIPTION OF THE ILLUSTRATIVE EMBODIMENTS

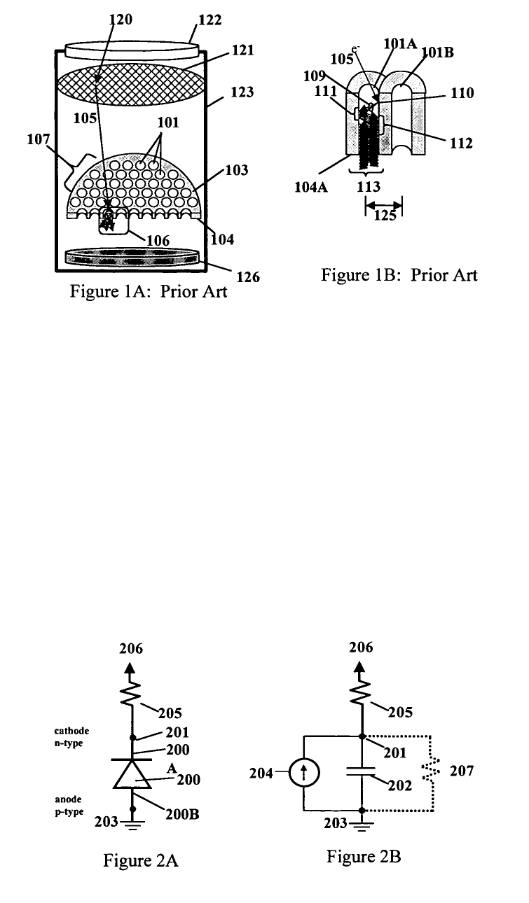

Reference is now made to FIG. 1A, showing a prior art approach to achieving high-speed, high sensitivity detection of optical photons using a microchannel plate (MCP) electron multiplier. Since MCP operation requires a high vacuum, the interior of 123 must be evacuated. A window 122 allows incident photons 120 to enter into the vacuum environment of the MCP. When an incident photon 120 with sufficient photon energy strikes a photocathode 121, a photoelectron 105 is ejected into the vacuum. An electrical field is applied between the photocathode 121 and the top of the MCP electron multiplier 103 in order to accelerate each photoelectron 105 towards the MCP plate 107. If a photoelectron 105 gains sufficient energy from this electrical field, and is incident on one of the pores 101 of the plate 107, it may impact ionize at the sidewalls of the pores 101, resulting in a cascade of electrons in an efficient, low-noise multiplication process. An electrical field is created down the pores 101 by applying a high voltage (usually in the range of 500-1500 V) between the top side 103 and the bottom side 104 of plate 107.

Reference is now made to FIG. 1B, showing a magnified view of region 106 of FIG. 1A. An incident photoelectron 105 is accelerated towards the sidewall of the exemplary pore 101A, resulting in a impact ionization at point 110, typically causing 0-10 secondary electrons 109 to be ejected. An electric field within the pore causes these secondary electrons 109 to be accelerated until they again encounter the side-wall of the pore at location 111, creating a second shower of secondary electrons, typically 0-10 secondary electrons per incident electron. This additional shower of secondary electrons is likewise accelerated down the pore until these electrons again encounter the side-wall of the pore at location 112, resulting in a third shower of secondary electrons. The process repeats itself until the final set of electrons 113 exits the plate 107 at the bottom 104A of the pore 101A. These exiting electrons are then accelerated into an anode 126, where they create a current that may be detected by external circuitry. The gain of each typical MCP pore is 1000-100,000 exiting electrons 113 for each incident photon 120, depending on the magnitude of the voltages applied between the photocathode 121 and the top 103 of the plate 107, between the top 103 and the bottom 104, and between the bottom 104 of the plate 107 and the anode 126. Adjacent MCP pores such as 101B are separated by a distance 125, typically 5-100 μm. It is important to note that when MCP electron multipliers are used to detect single photons, the gain of the pore is usually sufficient to deplete electrons from the side-walls of the pore, producing a long dead-time while replacement electrons replenish through a high resistance path that includes the top 103 and bottom 104 and the intrinsic resistance of the pore. This dead-time is typically longer than 1 μs.

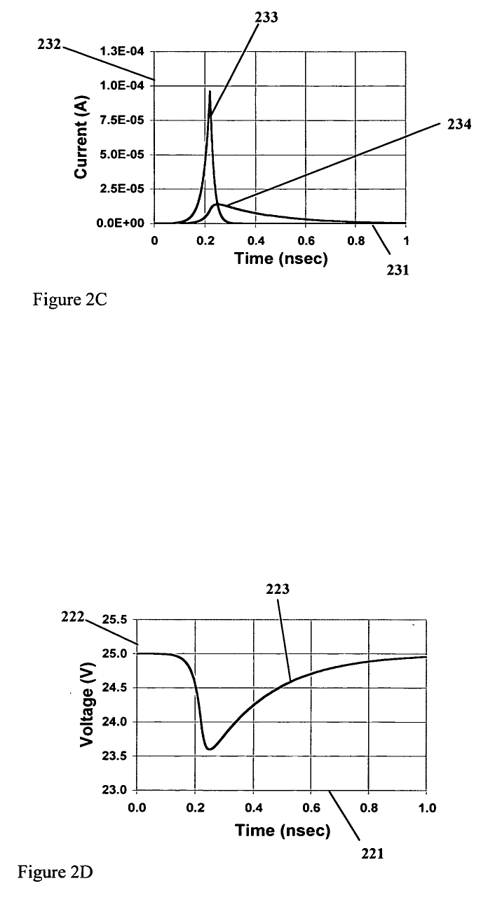

Reference is now made to FIG. 2A showing illustrative passive quench circuitry used to achieve low gain in a Geiger mode APD. In the simple passive quench configuration, a large value resistor 205 (typically between 100 kΩ and 1 MΩ) is connected in series with the SPAD 200 which is a reverse biased photodiode. When the bias voltage applied at 206 is larger in magnitude than the breakdown threshold voltage of the SPAD 200, a single photogenerated electron can initiate a Geiger avalanche event. If the SPAD 200 is “Off” and has not detected a photon, then the current flowing through it is low. Ideally, this current is zero, but in practice a current component may be flowing from the perimeter of the device. In a properly designed device this perimeter current does not experience Geiger mode gain because the electric field near the perimeter of the device is kept below the breakdown threshold, so the perimeter current is low compared with the current generated due to a Geiger event and can be ignored. Also note that in a properly designed SPAD, current fluctuations in the active region of the device will eventually go to zero when all free carriers are swept out of the active region, allowing the device to be biased beyond breakdown and into the regime of Geiger avalanche gain. The SPAD 200 is connected to resistor 205, nominally at point 201. In the figure, 200A refers to the cathode of the SPAD, corresponding to the n-type side of the diode, and 200B refers to the anode of the device, corresponding to the p-type side of the device. The anode 200B is connected to ground 203. The gain of SPAD 200 is dominated by three factors: the total capacitance of the device including parasitic capacitance, the amount of excess bias (bias beyond breakdown) applied across it, and the current-limiting response of the passive quench resistor. Any current that flows through the passive quench resistor during a quenching event acts to recharge the capacitance of the SPAD 200, so the SPAD 200 must exhibit a higher gain to discharge this additional current.

The primary factor determining the gain of a SPAD 200 is the total device capacitance (including all stray capacitance), which must be discharged by the Geiger current. In a properly designed passive quench circuit, the current through the passive quench resistor constitutes a small correction to the gain. Larger recharge currents, achieved with a smaller passive quench resistor, disadvantageously increase the gain, but smaller recharge currents, achieved with a larger passive quench resistor, disadvantageously increase the reset time after the device has quenched through the RC time constant of resistor 205 and the SPAD capacitance 202. Under the assumption of infinite passive quench resistor and instantaneous shutoff of current once the device has been quenched, the gain of a SPAD can be approximated by:
G=C×ΔV/q (1)
where ΔV is the bias above the breakdown voltage, or excess bias, on the SPAD pixel, and q is the charge of an electron. Equation 1 specifies the number of electrons needed to discharge the total capacitance C from a voltage of V_{BR}+ΔV to a voltage of V_{BR}, where V_{BR} is the breakdown voltage of the SPAD. In practice, the gain of the SPAD will be somewhat higher because the passive quench resistor 205 provides an additional charge component across capacitor C that must also be discharged to pull the SPAD bias voltage below V_{BR}, and the tail of the quench current persists for a short time after quenching, resulting in an additional discharging of the SPAD capacitor.

Gain can be controlled in several ways. It is a primary aspect of the invention to control the gain by achieving an appropriate value of the capacitance 202. Capacitance 202 can be lowered by minimizing parasitic capacitance, keeping the active area of the device small, and using a thick depletion region. Reducing the device's active area lowers the capacitance, hence the gain, but also reduces detectivity due to the smaller active area. Increasing the thickness of the depletion region lowers the capacitance and may increase the detection efficiency (due to an increased absorption length), but generally increases the thermal dark count rate. Increasing the thickness of the depletion region using a separate absorption and multiplication (SAM) structure does not increase the absorption length (the absorption thickness does not change), but may result in only a small increase in thermal dark counts because thermal dark counts in a SAM structure are often dominated by the high generation rate in the absorption region.

We note that lower excess bias ΔV via equation 1 can also be used to lower the SPAD gain. But, lowering the excess bias generally degrades detection efficiency by reducing the photodetector sensitivity. However, using a thick gain region enhances the positive feedback between electron and hole impact ionizations, increasing the Geiger probability at lower excess bias. In some embodiments, it may be possible to enhance the positive feedback between electron and hole impact ionizations by using a material in the gain region that has a near unity ratio of electron impact ionization to hole impact ionization coefficients. Therefore lowering the excess bias ΔV can be advantageous if it is achieved in a structure that enhances the Geiger probability by enhancing the positive feedback between electron and hole impact ionizations.

Fast passive quenching can self-quench and reset a SPAD pixel on a ns time-scale. Fast self-quenching is achieved by making the capacitance C of the pixel small (less than 1 pF), such that the internal current generated through the avalanche process is sufficient to discharge the capacitor to a value below breakdown. Fast reset is achieved by making the RC time constant of the passive quench circuit very short, where R is set by resistor element 205 and C is set by the device capacitance 202. Throughout this specification, we use the term resistor broadly, intending to encompass all resistive means and current-limiting resistive means, including lumped and distributed effects proportional to the ratio of voltage to current. Capacitance includes all effects proportional to the ratio of charge to voltage, including parasitics and the real part of the complex admittance.

The equivalent circuit diagram for a passively quenched SPAD is shown in FIG. 2B. This illustration is schematic, and intended to convey the concept in simplest form. It is not intended to exclude circuits with an effect which one with ordinary skill in the art would recognize as commensurate. By monolithically integrating the passive quench resistor 205, the intrinsic device capacitance of the SPAD 200 can be made to dominate the total device capacitance 202. The equivalent circuit shown in FIG. 2B includes a shunt resistor 207, which can be used to model the perimeter leakage current through the SPAD 200. The parallel-connected circuit elements of the current source 204, total device capacitance 202, and shunt resistor 207 form an equivalent circuit model of SPAD 200.

For the simplified numerical simulation of the SPAD 200 quenching response, shunt resistor 207 was neglected. The voltage change at node 201 due to the Geiger mode current is:
ΔV₁(t)=i₁(t)×R+(1/C)×∫i₂(t)δt (2)
where i₁(t) is the current through resistor 205, i₂(t) is the current through the capacitor 202, and ΔV₁(t) is the voltage drop across the capacitor at point 201. Note that ΔV₁(t) is also the voltage drop across resistor 205, allowing i₁(t) to be calculated (i₁(t)=ΔV₁(t)/R). For SPAD designs using small pixel capacitance 202 and large passive quench resistors 205, the Geiger mode gain of approximately C×ΔV₁/q.

Assuming a pixel has diameter of 5 μm, the capacitance 202 for a 1 μm semiconductor depletion layer thickness is roughly 2 fF (assuming low parasitic capacitance), so we calculate the gain to be approximately 1.1×10⁴×V_{excess}, where V_{excess} is the excess bias on the APD. A more accurate calculation indicates the gain is expected to be about 2×10⁴×V_{excess} due to charge replenishment through the passive quench resistor 205 (assumed to be a 100 kΩ and the tail of the current response i₂(t). Fast self-quenching is therefore achieved, because the current response i₂(t) rapidly discharges the capacitor to ground. Self-quenching achieve one aspect of this invention, namely limiting the gain of the pixel to 2×10⁴ electrons to quench each volt of excess bias. Since the Geiger mode gain is defined as the number of electrons emitted per Geiger event, fast self-quenching provides a means of limiting to less than 10⁶, which is a significant reduction over prior art techniques which generally achieve gains exceeding 10⁶ per Geiger event due to device capacitances C in excess of 1 pF.

Simple numerical modeling results of the fast passive quench circuit using equation 2 are shown in FIGS. 2C and 2D. In FIG. 2C, the plot shows current 232 as a function of time 231. Curve 233 represents the Geiger current 204 as a function of time, and was calculated by assuming that the doubling time constant for the SPAD was 5 ps when the device was biased above breakdown, the transit time through the depletion region of the SPAD was 10 ps, and the doubling time constant for the SPAD biased below breakdown was 20 ps. A doubling time constant of 5 ps with a transit time of 10 ps is self-sustaining and will grow exponentially with time, so constitutes a reasonable model of the internal response of the device when biased above breakdown threshold. A doubling time constant of 20 ps with a transit time of 10 ps when biased below the breakdown threshold is not self sustaining, and will eventually result in the current falling to zero, giving the current response 233. Note that a single photo-electron is injected into the active region at time zero, so the build-up time for the Geiger response is approximately 0.2 ns, in reasonable agreement with experimental results. Also shown in FIG. 2C is the recharge current 234 through resistor 205 as a function of time. The recharge current 234 rises as the voltage across the SPAD 200 drops, and continues after the Geiger response has completed, recharging the capacitor 202 and resetting SPAD 200 to an excess bias at node 201.

In FIG. 2D, the simulated voltage response 222 at node 201 is plotted as a function of time 221. In this example, SPAD 200 is biased to 25 V at time zero, which simulates 1 V of excess bias. The Geiger event lowers the voltage on SPAD 200, overshooting the breakdown voltage of 24 V, due to the tail of the current response 233. The voltage response 223 recovers back to 25 V due to the recharge current 234. The result is detection of a Geiger event with nearly complete recovery in less than 1 ns. Furthermore, the current response 233 is very fast, and it is this current response that would dominate the frequency response of a SPAD array using a low resistance common anode connection in accordance with the invention.

The Geiger avalanche multiplication process has an inherent exponential rise-time during the initial build-up of the Geiger event. For very small devices, the diffusion time constant for spreading the Geiger avalanche throughout the entire high field region of the device is negligible, though this is not true of large area devices where it may take more than 100 ps for an initial filamentary breakdown to spread across the entire area of the device. For SPADs operated under disadvantageous high gain conditions, this exponential rise will saturate as a result of space charge, increasing the quenching time and reducing performance.

Reference is now made to FIG. 2E, which shows a parallel-connection of N SPAD equivalent circuits. The first equivalent circuit 250A has a passive quench resistor 205A, a device equivalent capacitance 202A, a device current 204A, shunt resistor 207A and internal device node 201A. The second equivalent circuit 250B is identical, with passive quench resistor 205B, device equivalent capacitance 202B, device current 204B, shunt resistor 207B and internal device node 201B. Devices 250A and 250B are connected in parallel to the bias supply 206 and readout resistor 209 at node 203A as shown in the figure. Readout resistor 209 is connected to ground at node 203B. This parallel-connection is replicated for each element of the N element SPAD array. The last element of the parallel-connection is 250N, with passive quench resistor 205N, device equivalent capacitance 202N, device current 204N, shunt resistor 207N and internal device node 201N. The equivalent circuit model of N elements can be modeled using a circuit simulator such as SPICE.

Reference is now made to FIG. 2F, showing the SPICE simulation results for the circuit shown in FIG. 2E with 1 element, 100 elements, and 1000 elements connected in parallel. In the figure, axis 269 is the voltage at node 203A and axis 268 is time. For the SPICE simulations, the passive quench resistors 205A, 205B, . . . 205N are 100 kΩ, the device capacitances 202A, 202B . . . 202N are 1 pF, the shunt resistors 207A, 207B, . . . 207N are 100 GΩ, and the current source 204A, 204B, . . . 204N are Off (zero current) unless the device is triggered. The points 261 outline the voltage response of a single pixel when its current source is turned On (i.e. the current source 204A models a Geiger current pulse), and is similar to that shown in FIG. 2D. Line 262 is the voltage response of a series-connection of 100 parallel circuits (N=100) when only one current source (out of the 100 equivalent circuits) is turned On. Response 261 and 262 are practically identical. Dashed line 263 is the voltage response of a series-connection of 1000 parallel circuits (N=1000) when only one current source is turned On. We note that response 263 is slightly attenuated and exhibits slightly slower rising and falling edges, which may be an indication of a small amount of loading of the circuit by the parallel-connection of 1000 elements. Still, this result is significant because so little degradation is observed for 1000 parallel-connected SPADs if each SPAD element has a monolithically integrated series-connected passive quench resistor. In effect, the large value of the series resistance (205A, 205B, . . . 205N), as well as the very high effective resistance of the SPAD device when Off allows minimal loading of the parallel-connection, which enables a large number of SPADs to be connected in parallel without significant degradation of the output current response.

Reference is now made to FIG. 2G, which shows another set of SPICE simulation responses for circuit shown in FIG. 2E for a parallel-connection of 1000 equivalent circuits (N=1000) when 1, 2, and 10 of the current sources are turned On simultaneously. The voltage 279 is plotted as a function of time 278. Curve 273 is the voltage response when only one of the equivalent circuits is triggered. To simulate the triggering of a pixel, the current source 204 of the equivalent circuit of the device which is triggered is turned On, and all other current sources in all of the other equivalent circuits are turned Off (current is zero). The remaining 999 equivalent circuits are included in the simulation to provide an appropriate loading of the output. All other current sources of all the other equivalent circuits are Off (current is zero). Curve 272 is the voltage response when two (out of 1000 equivalent circuits) are triggered simultaneously, and the remaining 998 equivalent circuits do not have any internal current flowing, but are included in the simulation to provide the appropriate loading of the output response. The amplitude of curve 272 is almost exactly twice the amplitude of curve 273, indicating that the current summation method at node 203A provides an excellent summation of the outputs of the individual equivalent circuit. Curve 271 is the voltage response when 10 (out of 1000 equivalent circuits) are triggered simultaneously, with the remaining 990 equivalent circuits loading the output. The amplitude of curve 271 is 9.96 times larger than the amplitude of curve 273, which may indicate a small amount of loading by the other 9 triggered circuit elements, or may be due to a numerical roundoff error in the SPICE simulation. FIG. 2F shows the excellent linearity is achieved in the simulated model of the series-connection of 1000 SPAD elements.

It is important to note that the SPICE simulations show that the output of the simulated SPAD devices is not significantly loaded, even when the number of parallel-connected devices is 1000. This occurs because the high impedance of the “Off” SPAD devices results in almost an open circuit for these devices when they are not triggered. When a pixel is triggered, it may slightly load the output, but the series-connected passive quench resistor 205 still provides a relatively high impedance for the parallel-connection, minimizing loading. Thus, the parallel-connection of high impedance devices allows scaling to very large numbers of pixels without significant degradation in the output response. The internal gain of the SPAD devices results in high signal to noise and eliminates the need to have a dedicated amplifier at each pixel. Furthermore, because each SPAD pixel is small, the capacitance is small, allowing for high frequency response despite the series-connection of the passive quench resistor 205, which typically has a value in the range of 100 kΩ to 1 MΩ.

Next note that the series-connection of the passive quench resistor provides a means to tolerate bad pixels. If one of the series-connected pixels is shorted due to a manufacturing defect, the series-connected passive quench resistor provides a high impedance between the voltage supply 206 and ground 203, resulting in only a small amount of current flowing through a shorted pixel. For example, assume the voltage supply 206 is 100V and the passive quench resistor 205 is 100 kΩ, resulting in a leakage current of 1 mA. While this current does contribute a Shot noise component, this current is not amplified by the internal gain of a working SPAD pixel, and therefore the noise is suppressed by a factor of the gain, typically in the range of 10³ to 10⁶. This allows high performance to be achieved even in the presence of bad pixels. If a manufacturing defect results in an open circuit pixel, then no loading of the circuit occurs. Therefore both open circuited and shorted pixels do not destroy the performance of the SPAD pixel array, but rather may increase the readout noise, as well as resulting in a dead area of the detector that exhibits little or no photoresponse.

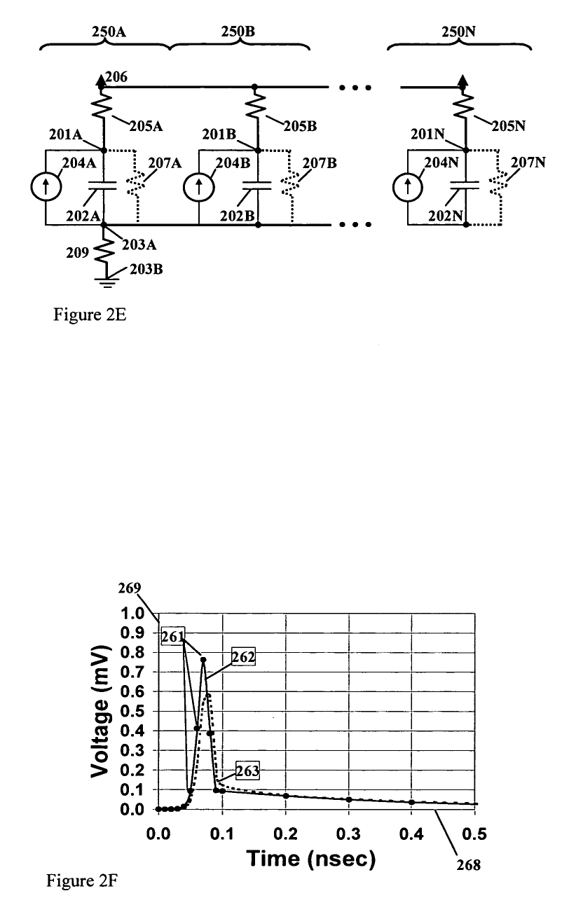

Reference is now made to FIG. 3, which illustrate the dependence of thermally generated dark counts on the choice of semiconductor materials in the active region of the SPAD.

Reducing the volume of the semiconductor active region of SPADs significantly reduces the dark count rate, and has made it possible for silicon SPADs to be operated at room temperature. (See S Vasile, P Gothoskar, R Farrell, and D Sdrulla, “Photon detection with high gain avalanche photodiode arrays,” IEEE Trans. Nuclear Science, 45, p. 720 (1998); M Ghioni, S Cova, I Rech, and F Zappa, “Monolithic Dual-Detector for Photon-Correlation Spectroscopy with wide Dynamic Range and 70-ps Resolution,” IEEE J. Quantum Electronics, 37, p. 1588 (2001); A Rochas, A R Pauchard, P-A Besse, D Pantic, Z Prijic, and RS Popovic, “Low-Noise Silicon Avalanche Photodiodes Fabricated in Conventional CMOS Technologies,” IEEE Trans. Elect. Dev., 49, p. 387 (2002); W J Kindt and H W van Zeijl, “Modeling and Fabrication of Geiger mode Avalanche Photodiodes,” IEEE Trans. Nuclear Science, 45, p. 715 (1998).) Cooling an APD also decreases the dark count rate, but only somewhat. (See S M Sze, Physics of Semiconductor Devices 2^{nd} edition, p. 90, John Wiley & Sons, New York (1981); K A McIntosh, J P Donnely, D C Oakley, A Napoleone, S D Calawa, L J Mahoney, K M Molvar, E K Duerr, S H Groves, and D C Shaver, “InGaAsP/InP avalanche photodiodes for photon counting at 1.06 μm,” Appl. Phys. Lett., 81, p. 2505 (2002).)

The generation rate of free carriers inside a semiconductor depletion region is given by:
G=nᵢ/τ_{SRH} (3)
where nᵢ is the intrinsic carrier concentration, G is the generation rate, and τ_{SRH} is the Schockley-Read-Hall recombination lifetime. Note that in some devices, the absorption region may not be depleted (See N Li, R Sidhu, Z Li, F Fa, X Zheng, S Wang, G Karve, S Demiguel, A L Holmes, Jr. and J Campbell, “InGaAs/InAlAs avalanche photodiode with undepleted absorber,” Applied Physics Letters, 82, p. 2175 (March 2003)), so the thermal generation rate given by equation 2 must be modified to account for minority carrier generation in doped regions. It is generally acceptable to treat τ_{SRH} as a slowly varying function of temperature, though nᵢ has exponential dependence on temperature:
nᵢ=\sqrt{N_{V}N_{C}}e^{-E}^{_{G}} (4)
where N_{C} and N_{V} are the conduction and valence band density of states, respectively, E_{G} is the band gap, k_{B} is Boltzmann's constant, and T is the absolute temperature. For silicon at room temperature, decreasing the temperature by 8.8° C. halves nᵢ, and halves the thermal generation rate, G. This is why silicon SPADs are often cooled with solid state thermoelectric coolers (TECs). By comparison, a hypothetical semiconductor with the same density of states and τ_{SRH} as silicon could achieve that same factor of two decrease in nᵢ if its band gap were merely 0.036 eV higher, without cooling. A slightly larger band gap material enables a spectacularly lower dark count SPAD.

Excessive cooling, however, leads to runaway after-pulsing, counter-intuitively making the photodetector more noisy. Defect-assisted tunneling becomes problematic at lower temperatures as well.

We calculated the noise equivalent power (“NEP”) expected for the devices built using the invention assuming that thermal generation dominates the dark count rate of the devices and the thermal generation rates shown in Table I. The NEP can be calculated from:
NEP=hv×√2×√J_{D}/(DE×FF) (5)
where J_{D} is the dark count rate, hv is the photon energy, DE is the single pixel detection efficiency for photons at the optical frequency v and FF is the fill factor of the array, which is equivalent to the fractional area of the photodetector array that is sensitive to incident photons.

Reference is now made to FIG. 3A, which shows the estimated thermal dark generation rate 398 as a function of temperature 399 for selected semiconductors. Curve 301 shows the thermal dark generation rate for InGaAs, Curve 302 shows the thermal dark generation rate for Ge, Curve 303 shows the thermal dark generation rate for InP, Curve 304 shows the thermal dark generation rate for GaAs, Curve 305 shows the thermal dark generation rate for Si, and Curve 306 shows the thermal dark generation rate for InGaP. By inspection, we see that the wide band gap of Ga_{0.5}In_{0.5}P is expected to achieve significantly lower thermal generation rate than silicon due to the decrease in nᵢ by a factor of 10⁸-10¹⁰, even in the presence of a large difference in τ_{SRH} in these materials. Furthermore, wide band gap semiconductors exhibit a stronger temperature dependence via equation 4, indicating that even modest cooling of these semiconductors greatly reduces their generation rate. While Si generally has the lowest τ_{SRH} due to the maturity and purity of its materials technology, it also has a very large nᵢ because of its relatively small band gap and high density of states in the conduction band. The conduction band density of states is large because silicon is an indirect band gap material, exhibiting a 6-fold degeneracy in its conduction band minimum and a shallow E-k dispersion relationship (i.e. a high density-of-states effective mass). State-of-the-art materials processing techniques for the lattice-matched compound semiconductors may result in generation lifetimes inferior to those for silicon by 5 orders of magnitude, which is still good enough to make the phenomenally smaller (8-10 orders of magnitude lower) nᵢ still out-compete higher τ_{SRH}.

Reference is now band to FIG. 3B, which shows the estimated thermal dark count rate 396 as a function of cutoff wavelength 397. Curves 311, 312 and 313 are “universal” curves independent of the material, showing the estimated dark count rates at 300 K, 250 K, and 200 K respectively. These “universal” curves were obtained by using InP as the prototype material, and scaling the intrinsic carrier concentration nᵢ as a function of band gap via equation 4. That is, all parameters for equation 4 correspond the InP, except for varying the band gap. The cutoff wavelength was assumed to be equal to the band gap. Also plotted in FIG. 3B are the 300 K results for selected semiconductors using the values in equation 2. The cutoff wavelength chosen for these semiconductors correspond to the cutoff wavelength listed in Table I, which corresponds to the wavelength where the absorption falls below 10% in these devices. Point 321 corresponds to the calculated thermal dark generation rate for GaInP at 300 K, point 322 corresponds to the calculated thermal dark generation rate for silicon at 300 K, point 323 corresponds to the calculated thermal dark generation rate for GaAs at 300 K, point 324 corresponds to the calculated thermal dark generation rate for InP at 300K, point 325 corresponds to the calculated thermal dark generation rate for Ge at 300K, point 326 corresponds to the calculated thermal dark generation rate for InGaAs at 300 K.

FIG. 3B illustrates the clear advantage of using wider band gap materials to reduce the thermally generated dark count rates. FIG. 3B also illustrates the point that even though silicon has exceptionally high materials quality, compound semiconductors can often outperform silicon. FIG. 3B also provides a guide for the selection of the semiconductor for the active region of the device and illustrates the utility of building a SAM APD structure, using a wider band gap gain region coupled to a smaller band gap absorption region. The smaller band gap absorption region is used to provide high efficiency absorption of the photons of interest, and the thickness of the absorption region can be chosen to balance the trade-off between absorption efficiency and dark count rate through equation 2. If the absorption region is coupled to a gain region with a wide enough band gap, the thermal dark count contribution of the gain region will be negligible, allowing significant freedom in the thickness of the gain region. Since one aspect of the invention is to control the gain by lowering the capacitance, it is a simple matter to lower the capacitance by making the gain region thicker, with no significant increase in the dark count rate. Indeed, a wider gain region also has the advantage of reduced tunneling (including defect-assisted tunneling), because a thicker gain region can generally operate at a slightly lower electrical field and still achieve the same detection efficiency. This is because the interaction length of carriers in the gain region is longer, allowing for more impact ionization events, and improved ratio of doubling time to transit time. It is advantageous to minimize tunneling because even a single electron tunneling through the depletion region is capable of initiating a dark count as a source of noise. The only major drawback to a wider gain region in a SAM structure is the need to increase applied voltage to because the threshold breakdown voltage scales linearly with gain region width.

TABLE I

| | GaInP | GaAs | InP | Si | InGaAs | Ge |
|---|---|---|---|---|---|---|
| Band gap Eg [eV] | 1.9 | 1.42 | 1.35 | 1.12 | 0.74 | 0.66 |
| Cutoff wavelength* | 650 nm | 870 nm | 930 nm | 775 nm | 1.7 μm | 1.46 μm |
| (absorption length = 10 μm) | | | | | | |
| Intrinsic carrier concentration | 2.8E2 | 2.7E6 | 1.4E7 | 8.7E9 | 9.6E11 | 2.0E13 |
| nᵢ [cm −3] | | | | | | |
| Change in temperature for | −4.4 | −6.4 | −6.9 | −8.2 | −11.3 | −12.1 |
| halving of [° C.] | | | | | | |
| Change in nᵢ for a −30° C. | 97-fold | 33-fold | 26-fold | 15-fold | 7.1-fold | 6.2-fold |
| change in temperature | | | | | | |
| Schockley-Read-Hall | 1 μs | 1 μs | 1 μs | 10 ms | 1 μs | 10 ms |
| lifetime, τ_{SRH} | | | | | | |
| Dark generation rate for a | 0.005 Hz | 50 Hz | 280 Hz | 17 Hz | 19 MHz | 390 kHz |
| typical 5 μm diameter | | | | | | |
| device | | | | | | |
| Integrated dark generation | 5 Hz | 50 kHz | 280 kHz | 17 kHz | 19 GHz | 390 MHz |
| rate for a 1000 pixel array | | | | | | |
| NEP of 1000 pixel array | 3.9E−18 | 3.0E−16 | 6.5E−16 | 2.7E−16 | 9.7E−14 | 2.0E−14 |
| (assumes 50% fill factor and | @ 640 nm | @ 850 nm | @ 920 nm | @ 540 nm | @ 1.6 μm | @ 1.1 μm |
| 50% detection-efficiency)** | | | | | | |

CAPTION: Calculated materials properties of various semiconductors. The active region thickness was assumed to be 1 μm for all semiconductors.
NOTES:
*Cutoff wavelength estimated by determining wavelength where the absorption length is 10 μm, resulting in a less than 10% probability of absorption for the incident photon. (Absorption coefficients from S Adachi, Optical Constants of Crystalline and Amorphous Semiconductors,” Kluwer Academic Publishers, Boston, 1999, and SR Kurtz et al., “Passivation of Interfaces in High Efficiency Photovoltaic Devices,” Materials Research Society Spring Meeting, May 1999).
**Wavelength for NEP estimation is chosen such that the absorption coefficient is at least 10⁵/cm, enabling a probability of incident photon absorption of at least 63%.

Reference is now made to FIG. 3C, showing the advantage of SPAD arrays over single pixel SPADs when the incident signal consists of more than one photon per light pulse. The rate of false positives 394 is plotted as a function of temperature 395. Curve 353 shows the calculated false positives rate when the threshold of a discriminator is set at a level to detect single Geiger events for a SPAD array example using an InGaAs absorption region for detection of 1.5 μm photons. Curve 353 is therefore just the calculated total dark count rate of the SPAD array. Curve 354 shows the calculated false positives rate when the threshold of a discriminator is set at a level to detect two simultaneous Geiger events but reject single Geiger events for the same SPAD array. By restricting our positive identification to correlated pairs of Geiger events, most of the un-correlated noise photons (due to thermally generated dark counts) can be rejected, significantly improving the SNR. Similarly, curve 355 shows the calculated false positives rate when the threshold of a discriminator is set at a level to detect 4 simultaneous Geiger events but reject any events with fewer simultaneous detection events. This curve shows a further reduction in the effective noise rate as uncorrelated dark events are more strongly suppressed. Also shown is curve 352 showing the single event thermal dark count rates for a similar SPAD array using InP in the active region of the device, as well as curve 351 showing the single event thermal dark count rates for a similar SPAD array using silicon in the active region of the device. FIG. 3C illustrates the utility of SPAD arrays for detecting correlated photon pulses, particularly for devices where background count rates are high. Note that even very low dark count rate SPAD arrays may have a high background count rate if operated under high ambient optical fluxes, so noise thresholding will be useful for these devices as well.

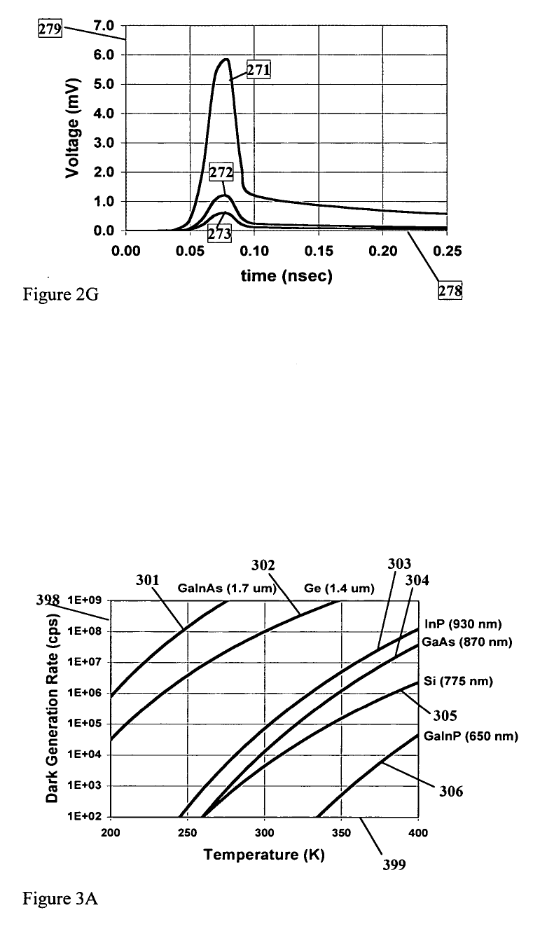

Reference is now made to FIG. 4, showing the preferred embodiment of the invention. FIG. 4A shows the layer stack of the preferred embodiment. The preferred embodiment is grown on a substrate 400 using conventional molecular beam epitaxy (MBE) or metal organic chemical vapor deposition (MOCVD). Substrate layer 400 may include an appropriate buffer layer also grown by MBE or MOCVD to provide improved semiconductor quality, if necessary. On top of substrate layer 400 is grown contact layer 401 to a thickness 421. In the preferred embodiment, this contact layer is used to form a low resistance contact to the common anode (or common cathode, depending on the doping). On top of contact layer 401 is grown absorption region 403 to thickness 423. The thickness and composition of region 403 is chosen to provide an optimal trade between absorption efficiency and dark count rate. On top of absorption region 403 is grown a charge control layer 405 with a thickness 425. The layer 405 serves to reduce the electrical field in layer 403, advantageously allowing the magnitude of the electrical fields in layers 403 and 407 to be different. Layer 407 is the gain region, and in general is produced in a material with different properties from the absorption region. Generally, layer 407 has a larger band gap than layer 403, hence a large breakdown field. Charge control layer 405 therefore provides a means for allowing the electrical field in layer 407 to be large enough to initiate breakdown (and therefore initiate Geiger events), while keeping the field in layer 403 sufficiently low to avoid breakdown in layer 403. Breakdown in layer 403 is also generally avoided because the breakdown characteristics of layer 407 advantageously exhibit breakdown properties at least as good (e.g. less tunneling) as those in layer 403. The combination of layers 407, 405, and 403 is often referred to as a SAM APD (or SACM APD) structure, by allowing separation of the absorption (and collection) and multiplication functions of the device. Layer 407 is grown to a thickness 427. On top of layer 407 is grown a contact layer 409 to a thickness 429. Contact layer 407 allows ohmic contact to the cathode (or anode, depending on doping type) side of the device. On top of layer 409 is deposited transparent resistive layer 411 with a thickness of 431. Layer 411 may consist of an epitaxially grown layer provide sufficiently high resistance can be achieved using semiconductor materials, or layer 411 may consist of a post growth deposited layer, such as amorphous silicon carbide. The materials and thickness 431 of layer 411 are chosen such that layer 411 can be fabricated into the passive quench resistor. Obviously, the layers 403, 405 and 407 can equivalently be grown upside down, in the opposite time sequence, or both.

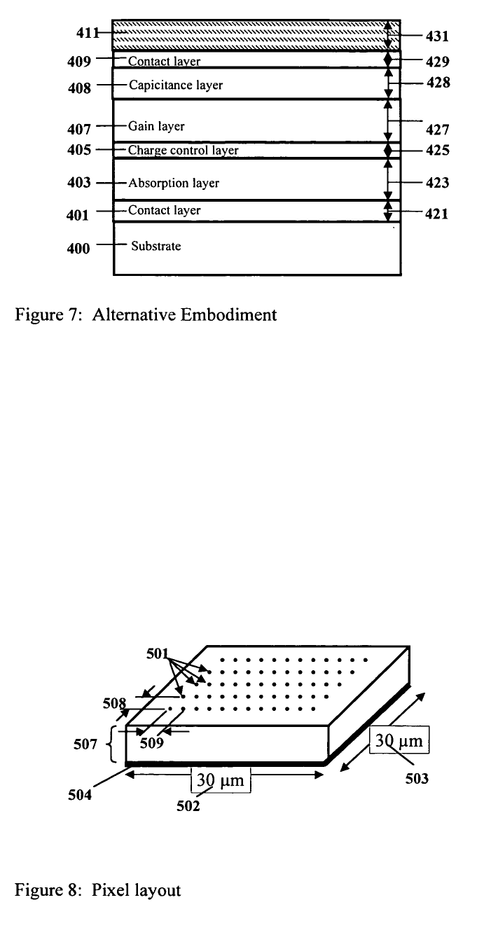

Reference is now made to FIG. 4B, showing how two pixels 499 of a solid state microchannel plate may be fabricated using mesa trench isolation 471 between pixels. The solid state microchannel plate detector is analogous to the vacuum MCP shown in FIGS. 1A & 1B, where the pores 101 of the vacuum MCP are replaced by SPAD pixels 499, the photocathode 121 is replaced by the absorption region 403, impact ionization occurs in the gain region 407, and the vacuum anode 126 is replaced by the semiconductor contact layer 401. Mesa trench isolation is useful to reduced optical cross talk, and further reductions in optical cross talk can be achieved by inserting an opaque material into trench 471. As shown in the Figure, transparent resistive layer 411 is deposited on top of the layer structure of the preferred embodiment. Transparent conducting contacts 206A and 206B make ohmic contact to one side of resistive layer 411, and contacts 206A and 206B are electrically connected together at bias supply 206Z. With mesa-isolated pixels such as those shown in FIG. 8, mesa side-wall 470 passivation is important, because it is advantageous to prevent avalanche breakdown at mesa side-wall 470, and to keep perimeter leakage current generated at mesa side-wall 470 low.

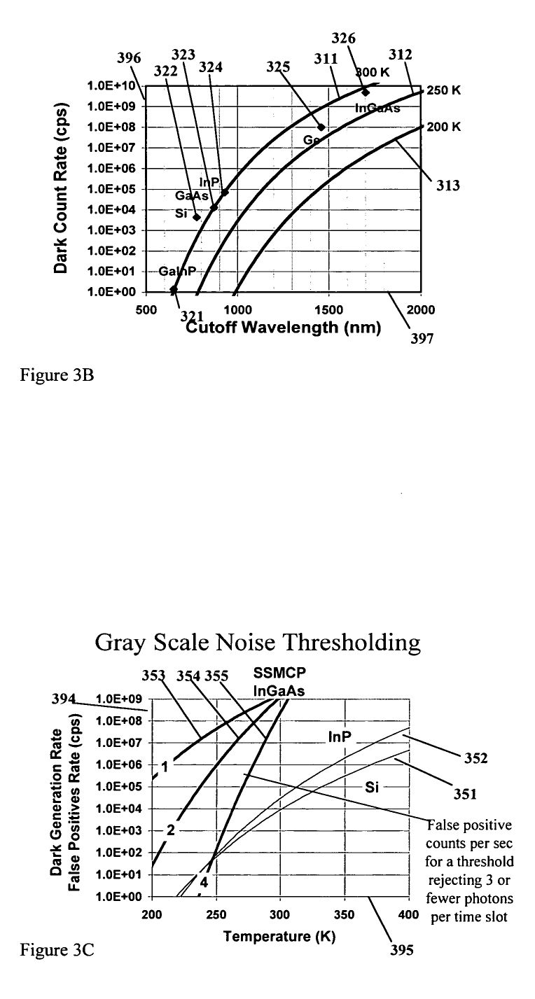

Reference is now made to FIG. 5, showing an alternative embodiment using guard rings 411D and 411E to shape the electrical field 414. Resistor layer 411 is deposited on top of layer 409 to achieve the desired passive quench resistance value. Resistor layer 411 is patterned into mesas 411A and 411B, which provide ohmic contact to the active region of the device, and mesas 411D and 411E, which provide a guard ring function. Contacts 206A and 206B make ohmic contact to mesas 411A and 411B respectively, and are connected to a first voltage supply at 206Z. Contacts 206D and 206E are connected to mesas 411D and 411E respectively, and act as guard rings to shape the electrical field profile 414. Contacts 206D and 206E may be connected to a second voltage supply, chosen such that their voltage is lower than the first voltage supply by an amount chosen to provide optimal guard ring functionality. The guard ring shapes the electrical field profile 414 in order to reduce perimeter effects and enhance the uniformity of the SPAD avalanche gain.

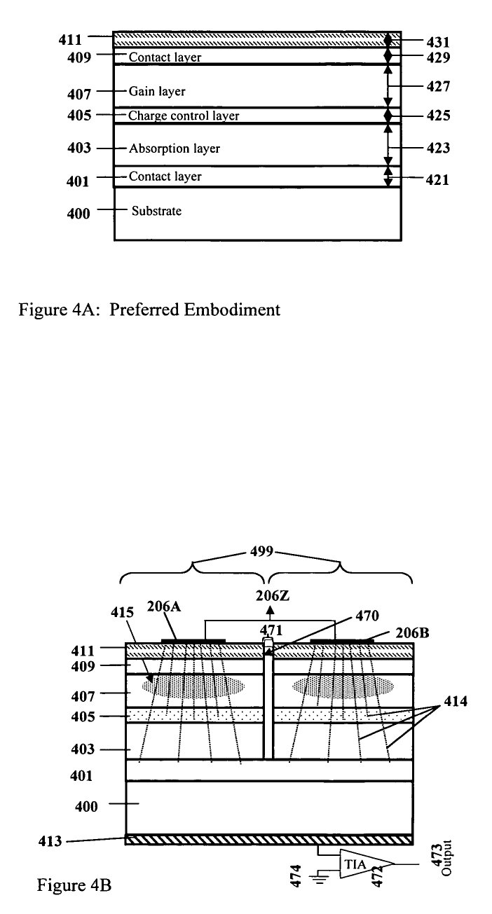

Reference is now made to FIG. 6, showing an alternative embodiment layer structure where resistive layer 411 has been replaced with buried resistive layer 411Y, which can be achieved by epitaxially growing resistive layer 411Y to a thickness 431Y between layers 400 and 401. The composition of layer 411Y and thickness 431Y are chosen to provide the appropriate passive quench resistor values. Devices in accordance with the invention may now be fabricated in accordance with FIGS. 4B and 5 but with the resistor layer 411 eliminated (i.e. set thickness 431 to zero).

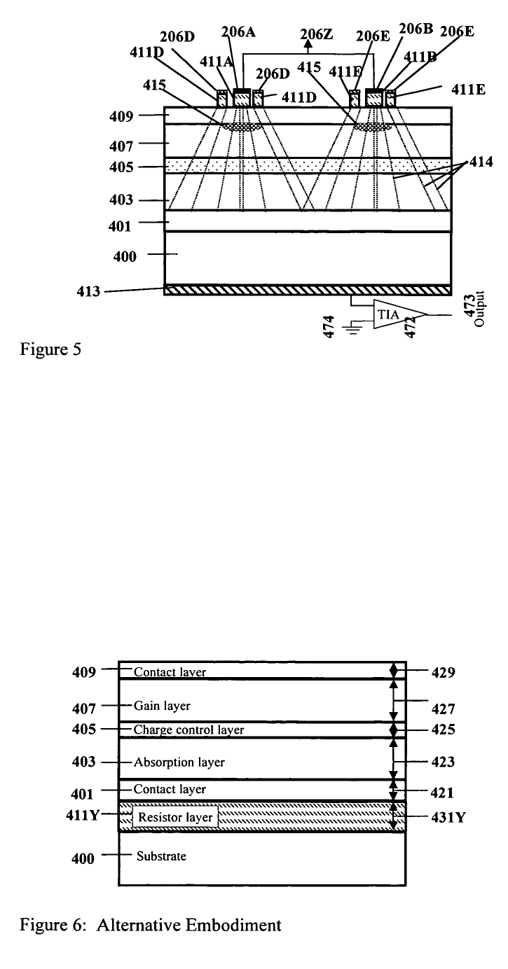

Reference is now made to FIG. 7, showing an alternative layer structure with an additional, capacitance reduction layer 408 with a thickness 428 inserted into the depletion region of the device. In this embodiment, layer 408 is made from a semiconducting material with a higher breakdown field than the gain layer 407, and therefore does not exhibit significant avalanche gain under normal operating conditions. Instead, layer 408 just acts to decrease the capacitance of the device by increasing the total thickness of the depletion region. Here, the depletion region includes layer 403, 405, 407, 408, and portions of 401 and 409. Insertion of layer 408 enables the device designer to separate the capacitance of the device from the absorption region 403 and gain region 407 characteristics, which therefore enables separate control of the Geiger mode gain of the device.

Reference is now made to FIG. 8, showing how SPAD elements can be arranged on a square lattice in accordance with the invention. Elements 501 are individual SPAD photodetector elements, including the integrated passive quench circuitry. The lateral spacing between pixels in a first direction is 509, and the lateral spacing between pixels in a second direction is 508. Dimension 502 is the lateral dimension of the array photodetector in the horizontal direction, and dimension 503 is the lateral dimension of the array photodetector in the vertical direction. Region 507 include the SPAD layers and passive quench circuit elements, with the pixels formed in accordance with the invention. Contact 504 is the common anode connection, which provides a common connection to the anode of all of the pixel elements 501.

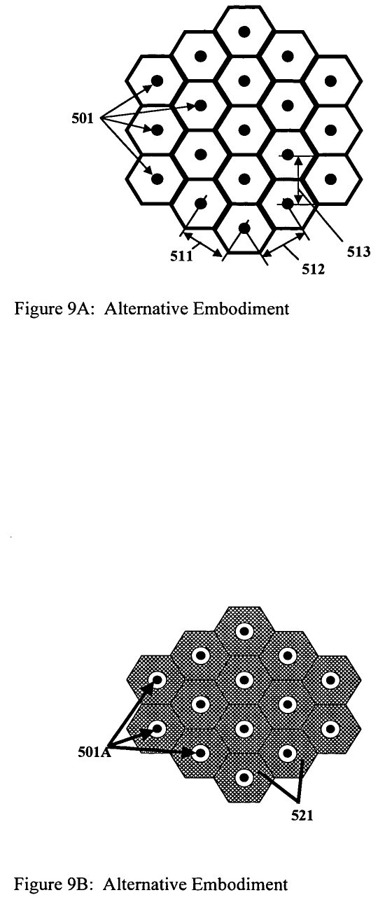

Reference is now made to FIG. 9A, showing an alternative pixel layout on a hexagonal close-packed lattice. Pixel elements 501 are placed on a hexagonal close-packed lattice with length 511, 512, and 513 between pixels as shown. In one embodiment, lengths 511, 512, and 513 are all equivalent. Please note that a hexagonal close-packed shape has the highest fill factor by virtue of using the area most efficiently, but is merely suggestive of area-filling shapes. It is not strictly necessary for the multiplicity of photodetector elements to be spaced regularly, nor necessarily on a repeating grid, nor necessarily with long-range order.

Reference is now made to FIG. 9B, showing an alternative embodiment using a hexagonal close-packed lattice. Contacts 501A make ohmic contact to each pixel element. Contact 521 is a large area guard ring structure used to shape the field around photodetector elements and reduce perimeter effects in accordance with well known principles of guard rings.

The applicants intend to seek, and ultimately receive, claims to all aspects, features and applications of the current invention, both through the present application and through continuing applications, as permitted by 35 U.S.C. §120, etc. Accordingly, no inference should be drawn that applicants have surrendered, or intend to surrender, any potentially patentable subject matter disclosed in this application, but not presently claimed. In this regard, potential infringers should specifically understand that applicants may have one or more additional applications pending, that such additional applications may contain similar, different, narrower or broader claims, and that one or more of such additional applications may be designated as not for publication prior to grant.

We claim:

1. A photodetector component aggregating a multiplicity of photodiodes, each photodiode having a capability for converting an incident photon into a multiplicity of charge carriers, said multiplicity of charge carriers comprising between 100 and 1,000,000 electrons or holes, said photodiode connecting to a cathode separated from said photodiode by a resistance of at least 10 kΩ, and said multiplicity of photodiodes connecting to a common anode.

2. The apparatus of claim 1 wherein Geiger mode gain provides said capability for converting.

3. The apparatus of claim 1 further including an equivalent circuit including said photodiode, wherein said capability for converting is bounded by the capacitance and bias of said equivalent circuit more than by the internal gain mechanism of said photodiode.

4. The apparatus of claim 1 wherein the variation in said multiplicity of charge carriers is less than 10% among said photodiodes comprising said multiplicity of photodiodes.

5. The apparatus of claim 1 wherein said multiplicity of charge carriers comprises at least 1000 electrons or holes.

6. The apparatus of claim 5 wherein said multiplicity of charge carriers comprises at least 10,000 electrons or holes.

7. The apparatus of claim 1 wherein said multiplicity of charge carriers comprises less than 10,000 electrons or holes.

8. The apparatus of claim 7 wherein said multiplicity of charge carriers comprises less than 100,000 electrons or holes.

9. The apparatus of claim 1 wherein said resistance is at least 100 kΩ.

10. The apparatus of claim 1 using an anode and common cathode instead of a cathode and common anode.

11. The apparatus of claim 1 wherein said multiplicity of photodiodes comprises at least 1000 photodiodes.

12. The apparatus of claim 1 wherein the average integrated within the gain region of the ratio of the cross sections for impact-ionizing holes versus electrons is between 0.5 and 2.0.

13. A photodetector component aggregating a first number of Geiger mode photodiodes, connected to a second number of anodes or cathodes shared in common among said photodiodes, said first number being greater than said second number, and said first number being greater than 100.

14. The apparatus of claim 13 wherein said first number is greater than 1000.

15. The apparatus of claim 13 wherein said first number is greater than 10,000.

16. The apparatus of claim 13 wherein said second number is 1.

17. The apparatus of claim 13 wherein the ratio of said first number to said second number exceeds 30.

18. The apparatus of claim 17 wherein the ratio of said first number to said second number exceeds 100.

19. The apparatus of claim 13 wherein the photosensitive area of said photodetector component exceeds 1 mm².

20. The apparatus of claim 19 wherein the photosensitive area of said photodetector component exceeds 10 mm².

21. The apparatus of claim 13 comprising an array of gray-scale pixels, wherein each of said pixels connects to an anode or cathode shared in common among a subset of said multiplicity of photodiodes.

22. The apparatus of claim 21 wherein said array of gray-scale pixels forms a line.

23. A method for detecting a dim optical signal over a photosensitive area of at least 1 mm², comprising the steps of dividing said signal among a multiplicity of photodiodes, converting said optical signal into an electrical representation in each of said photodiodes with a gain factor limited by the equivalent circuit including each of said photodiodes, and accumulating the charge from each of said photodiodes at a common anode or cathode.

24. The method of claim 23 wherein limiting of the gain factor is accomplished by requiring each of said photodiodes to have a capacitance less than 100 fF and an excess bias less than 10 V.

25. The method of claim 24 wherein limiting of the gain factor is accomplished by requiring each of said photodiodes to have a capacitance less than 10 fF and an excess bias less than 10 V.

26. The method of claim 23 wherein limiting of the gain factor is accomplished by requiring each of said photodiodes to have an excess bias less than 1 V.
